(19) United States
(12) Patent Application Publication
(10) Pub. No.: US 2023/0075596 A1
(43) Pub. Date: Mar. 9, 2023

(54) BATCH EVENT DELIVERY WITH IDENTIFIERS

(71) Applicant: Twitter, Inc., San Francisco, CA (US)

(72) Inventors: Lohit Vijaya Renu, Santa Clara, CA (US); Zhenzhao Wang, San Francisco, CA (US)

(21) Appl. No.: 17/877,039

(22) Filed: Jul. 29, 2022

Related U.S. Application Data
(60) Provisional application No. 63/240,593, filed on Sep. 3, 2021.

(51) Int. Cl. G06F 9/48; G06F 9/46; G06F 9/54

(52) U.S. Cl. CPC G06F 9/4881; G06F 9/466; G06F 9/544

(57) ABSTRACT

Methods, systems, and apparatus, including computer programs encoded on computer storage media, for improved delivery likelihood of batch events. One of the methods includes receiving, from an upstream system in an event processing pipeline, a request to store a first batch of events in persistent memory, the request including the first batch of events and a first identifier for the first batch of events; providing, to a downstream system in the event processing pipeline, a data storage request that includes the first batch of events and the first identifier; receiving, from the downstream system, the first confirmation that includes the first identifier and indicates that the first batch of events was successfully committed; and in response to receiving the first confirmation: sending, to the upstream system, a second confirmation message that includes the first identifier and indicates that the first batch of events was successfully committed.

### CROSS-REFERENCE TO RELATED APPLICATIONS

This application claims the benefit under 35 U.S.C. § 119(e) of the filing date of U.S. Patent Application No. 63/240,593, entitled “BATCH EVENT DELIVERY WITH IDENTIFIERS,” which was filed on Sep. 3, 2021, and which is incorporated here by reference.

### BACKGROUND

This specification relates to batch event delivery, specifically improving a likelihood of batch event delivery.

Devices can store data in non-persistent or persistent memory. For instance, a device can store data in persistent memory within a database.

Client devices can send requests to servers. The requests can be for data, e.g., retrieval of a web page or search results, or for storage of data. For instance, a client device can request that a server store data on the server, e.g., when the server is part of a cloud system.

### SUMMARY

To improve a likelihood, or alternatively provide a guarantee, that a transaction is completed, e.g., that events are stored in persistent memory, while maintaining a high system throughput, a system can use batches of events with corresponding identifiers. The system can send a batch of events along with the corresponding batch identifier to a downstream system, e.g., that includes persistent memory. The system can maintain the batch of events and the identifier in a buffer until the system receives a confirmation that the batch was stored in persistent memory. When the system receives a confirmation that includes the batch identifier, the system can determine that the batch was successfully stored and remove the batch of events and the batch identifier from the buffer. If the system does not receive a confirmation that includes the batch identifier within a predetermined time period, the system can resend the batch of events with the batch identifier to a downstream system, e.g., either the same downstream system or another downstream system.

In general, one aspect of the subject matter described in this specification can be embodied in methods that include the actions of receiving, from an upstream system in an event processing pipeline that includes a plurality of systems within one or more layers a) including a persistent memory layer and b) at least some layers of which perform different event processing on an event that passes through the event processing pipeline after the event is received by an initiating layer, a request to store a first batch of events in persistent memory of the persistent memory layer in the event processing pipeline, the request including i) the first batch of events and ii) a first identifier for the first batch of events; initiating a first transaction for the first batch of events; providing, to a downstream system in the event processing pipeline, a data storage request that includes i) the first batch of events for storage in persistent memory of the event processing pipeline and ii) the first identifier for the first batch of events; receiving, from the downstream system, the first confirmation that a) includes the first identifier for the first batch of events and b) indicates that the first batch of events was successfully committed to the persistent memory of the persistent memory layer in the event processing pipeline; and in response to receiving the first confirmation: committing the first transaction for the first batch of events with the first identifier; and sending, to the upstream system, a second confirmation message that includes the first identifier for the first batch of events and indicates that the first batch of events was successfully committed.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the method can include while waiting to receive a first confirmation that indicates that the first batch of events was successfully committed to the persistent memory of the persistent memory layer in the event processing pipeline, initiating a second transaction for a second batch of events that is a different batch than the first batch of events. Committing the first transaction for the first batch of events with the first identifier can include removing data for the first batch of events from a buffer. The first identifier can include a timestamp for the first batch of events and a client identifier for a client device that created the first batch of events. A client device can select a number of events for the first batch of events using at least one of: (i) a time period during which the events in the first batch of events were created, or (ii) a size of the events included in the first batch of events.

In some implementations, the method can include for a third batch of events that is a different batch than the first batch of events: initiating a third transaction for the third batch of events with a third identifier including storing data for the third batch of events in a buffer; providing, to a second downstream system, a second data storage request that includes i) the third batch of events for storage in the persistent memory of the persistent memory layer and ii) the third identifier; determining that a threshold period of time has passed after providing the second data storage request without receiving a second confirmation that a) includes the third identifier and b) indicates that the third batch of events was successfully committed to the persistent memory of the persistent memory layer; and in response to determining that the threshold period of time has passed after providing the second data storage request without receiving the second confirmation, providing, to a third downstream system and using the data for the third batch of events that was stored in the buffer, a third data storage request that includes i) the third batch of events for storage in the persistent memory of the persistent memory layer and ii) the third identifier. At least one of the first batch of events, the second batch of events, or the third batch of events can include two or more events. The second downstream system can be the same system as the third downstream system. The second data storage request can include the same data values as the third data storage request.

In some implementations, the method can include after initiating the first transaction for the first batch of events and before committing the first transaction for the first batch of events: receiving a second request to store the second batch of events in the persistent memory of the persistent memory layer in the event processing pipeline, the second request including i) the second batch of events and ii) a second identifier for the second batch of events; initiating the second transaction for the second batch of events; and providing a second data storage request that includes i) the second batch of events for storage in the persistent memory of the persistent memory layer in the event processing pipeline and ii) the second identifier for the second batch of events.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. In some implementations, the systems and methods described in this specification, e.g., the use of batch identifiers, can reduce a likelihood that events will be lost because of network failures, system failures, software problems, or a combination of two or more of these. In some implementations, the systems and methods described in this specification, e.g., the use of batch identifiers for a batch of events, can improve processing time, system scale, or both, compared to other systems, e.g., that do not use event batches, batch identifiers, or both. For instance, the systems and methods described in this specification can have better processing time than a system that acknowledges each event and commits it to storage, which cannot scale for systems that handle a large number of events per minute, e.g., billions of events per minute.

In some implementations, the systems and methods described in this specification can reduce a number of bottlenecks in an event processing pipeline, e.g., so that available network capacity is the most likely, or only, event processing pipeline bottleneck. In some implementations, the systems and methods described in this specification can reduce a likelihood that an event, or a batch of events, will need to be stored in a persistent storage before reaching a final destination, e.g., a storage system. In some implementations, the systems and methods described in this specification can reduce an amount of processing resources required by an event processing pipeline to process events. For example, the systems described in this specification can require less processing time, fewer resources, e.g., for persistent storage, or both, compared to other systems, e.g., that store events in persistent storage at each layer of an event processing pipeline. This can occur when a client need not resend the same event for storage in a persistent storage upon receipt of an commit confirmation message, compared to other systems that do not use commit confirmation messages and might need to resend the same event for storage in persistent storage event though the event was successfully committed to the persistent storage.

In some implementations, the systems and methods described in this specification can have improved atomicity compared to other systems, reduce a likelihood that an event will need to be resent for storage in a persistent storage, or both. For instance, a system with a persistent storage can have an improved atomicity, e.g., reduced, eliminated, or both, for data stored in the persistent storage by removing events from the persistent storage that have the same identifier, not storing events in the persistent storage that have the same identifier, or both.

In some implementations, the systems and methods described in this specification, e.g., that use event batches with identifiers, can maximize throughput for an event processing pipeline to handle billions of events per minute, operate at tens of terabytes of data per minute, or both. For instance, use of per event identifiers by a system would much more expensive and not feasible at a large scale compared to the use of event batches with identifiers. In some implementations, the systems and methods described in this specification can dynamically adjust a batch size using the size of events in an event stream, a load for an event processing pipeline, an event type, or a combination of these. This can enable the systems to generate batches, for example, with a thousand events and batches with a hundred events dynamically, depending on various parameters for the event processing pipeline and the events, which optimizes the event processing pipeline compared to other systems.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment for batch event delivery.

FIG. 2 is a flow diagram of an example process for providing a batch of events for persistent storage.

Like reference numbers and designations in the various drawings indicate like elements.

### DETAILED DESCRIPTION

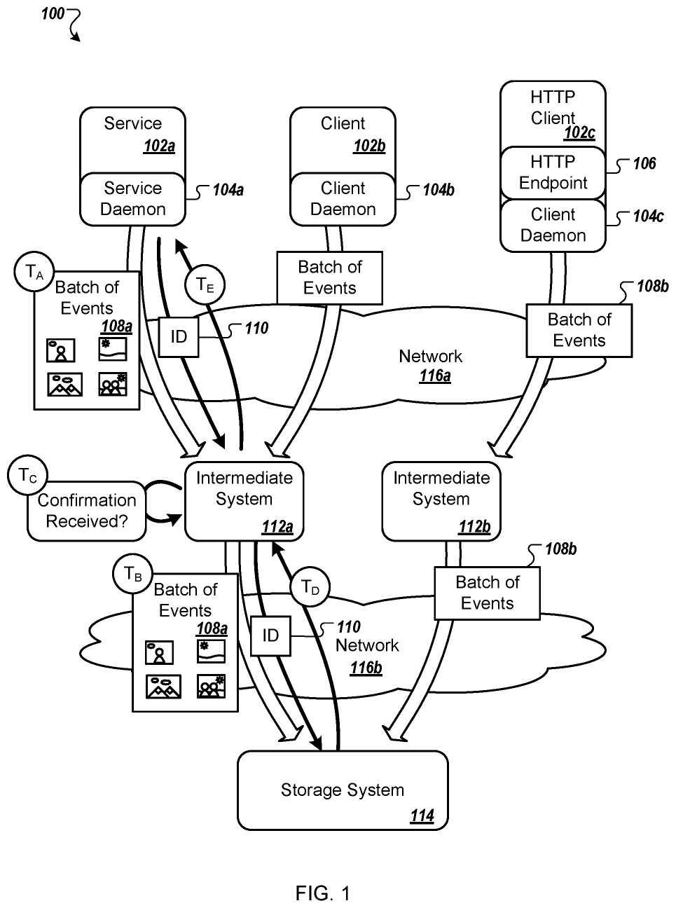

FIG. 1 depicts an example environment 100 for batch event delivery. In the environment 100, data processing systems, e.g., intermediate systems 112a-b, can perform event processing at scale. Some types of event processing include collection and aggregation. An event can be data for an action or occurrence on a computer system. For instance, an event can be data for a message that was generated, e.g., a tweet; or an image, e.g., captured by a camera or otherwise retrieved from memory. An event can be other appropriate data that can be used to present content on a device.

Hundreds of thousands of clients, e.g., service 102a and clients 102b-c, can emit events. For instance, daemons 104a-c running on the clients 102a-c, respectively, can emit events based on actions or occurrences for the corresponding clients 102a-c, on the underlying systems, e.g., hardware, or both.

The daemons 104a-c can emit the events based on the clients 102a-c directly or through interaction with another application. For instance, an HTTP client 102c can include an HTTP endpoint 106. The client daemon 104c can detect actions or occurrences for the HTTP endpoint 106 and emit corresponding events.

These events can travel through multiple layers, e.g., systems such as the intermediate systems 112a-b, of an event processing pipeline before reaching a desired destination, e.g., a storage system 114, including in the event processing pipeline. The storage system 114 can be a persistent storage that maintains multiple events in one or more memories. Although the environment 100 depicts an event processing pipeline with a single layer for the intermediate systems 112a-b, some environments 100 and event processing pipelines include two or more layers, e.g., an aggregation layer, an intermediate storage layer, an event processing layer, or a combination of two or more of these. In some examples, the clients 102a-c can be part of an initiating layer in an event processing pipeline. In some examples, the initiating layer includes systems other than the clients 102a-c, e.g., the initiating layer can include the intermediate systems 112a-b.

As events pass through these multiple layers, some events can get lost because of network failures, system failures, software problems, other errors, or a combination of these. For instance, when the service 102a sends an event to the intermediate system 112a and the intermediate system 112a fails before the intermediate system 112a finishes processing the event, the event can be lost.

To improve a likelihood that events are delivered, reduce processing time, or both, the environment 100 uses batch identifiers 110. A batch identifier 110 has a batch of events 108a-b to which the batch identifier 110 corresponds. As the batch of events 108a-b moves through the environment 100, and is processed by different intermediate systems, e.g., the intermediate systems 112a-b, before reaching a destination, e.g., the storage system 114, the batch of events 108a-b maintains the same batch identifier 110. This pairing of a batch of events 108a-b with a single batch identifier 110 is maintained, even if an intermediate system changes data in a batch of events 108a-b during processing.

The clients 102a-c generate batches of events 108a-b. The clients 102a-c can generate a batch of events using any appropriate process. For instance, the clients 102a-c can use a maximum batch size, a time period during which events are generated, an event type, or a combination of two or more of these, to generate a batch of events 108a-b.

The service 102a can generate the batch of events 108a, here with multiple images, using a maximum batch size. The service daemon 104a can determine a size for each of the multiple images. When the service daemon 104a determines that adding an additional image to a batch would cause the batch size to not satisfy the maximum batch size, e.g., to be the same as or greater than or either, the service daemon 104a can determine to create a batch of events 108a using the selected images, create a batch of events 108a using the selected images, or both.

The service daemon 104a can generate a batch identifier 110, e.g., a transaction identifier, for the batch of events 108a. The service daemon 104a can use any appropriate process to generate the batch identifier 110. For instance, the batch identifier 110 can be a time stamp that indicates a time for the batch of events 108a, e.g., a time when the batch of events 108a was generated, the generation process began, or another appropriate time. The batch identifier 110 can include an identifier for the service 102a.

During time period T_{A}, the service daemon 104a, or another appropriate component of the service 102a, can send the batch of events 108a with the batch identifier 110 to an intermediate system 112a. For example, the service daemon 104a can send a message to the intermediate system 112a that includes the batch of events 108a and the batch identifier 110.

The intermediate system 112a receives the message that includes the batch of events 108a and the batch identifier 110. The message can be part of a request, from the service daemon 104a, to store the batch of events 108a in persistent memory. The message can be part of another appropriate request. In some examples, the intermediate system 112a receives the message from the service 102a. In some examples, the intermediate system 112a receives the message from another intermediate system, e.g., between the service 102a and the intermediate system 112a.

The intermediate system 112a can process the batch of events 108a. For instance, the intermediate system 112a can maintain data for the batch of events 108a and the batch identifier 110 in memory, e.g., random access memory. The intermediate system 112a can process the batch of events 108a by collecting, aggregating, or determining metrics for events in the batch of events 108a, to name a few examples. In some examples, the intermediate system 112a can be a proxy system for the batch of events 108a.

The intermediate system 112a can maintain data for the batch identifier 110 as a tuple, e.g., an identifier for the service 102a with the batch identifier 110. The intermediate system 112a, or another intermediate system, can use the tuple as the identifier for the batch of events 108a. For example, the intermediate system 112a can provide the tuple to another downstream system, such as the storage system 114, instead of or in addition to providing the batch identifier 110.

The batch identifier 110 can be unique within the environment 100. For instance, when the batch identifier 110 includes an identifier for the client 102a-c and an identifier for the batch of events 108, the combination of these two identifiers, e.g., as a tuple, can be unique in the environment 100. Although a first client 102a-c might generate an identifier for a first batch of events 108 that is the same as the identifier for a second batch of events 108 generated by a second client, the combination of the client identifier with the identifier for the batch of events 108 would make the batch identifiers 110 for the two batches unique. This would ensure that the systems and devices in the environment 100 refer to each batch of events 108 using a different identifier. Uniqueness of the batch identifier 110 can be ensured when each client device 102a-c only generates unique identifiers for the batches of events 108 that the client device generates.

During time period T_{B}, the intermediate system 112a provides the batch of events 108a and the batch identifier 110 to a downstream system. The downstream system can be the storage system 114 or another intermediate system. When the first intermediate system 112 provides the batch of events 108a to another intermediate system, the other intermediate system or another system can eventually provide the batch of events 108a to the storage system 114.

While waiting for a response from the downstream system, the intermediate system 112a maintains the batch of events 108a and the batch identifier 110 in memory. For example, the first intermediate system 112 does not persist the batch of events 108a or the batch identifier 110 to persistent memory. Instead, the intermediate systems in the environment 100 maintain the batch of events 108a, the batch identifier 110, or both, in non-persistent memory. The intermediate systems can stream the batch of events 108a-b across one or more networks 116a-b to different systems that handle the batch of events 108a-b in non-persistent memory and then send the batch of events 108a-b downstream with the batch identifier 110 until the storage system 114 receives the batch of events 108a-b.

When the storage system 114 receives the batch of events 108a and the batch identifier 110, the storage system 114 commits the batch of events 108a to persistent storage. For instance, the storage system 114 stores the batch of events 108a in one or more computer storage devices. This can include storing the batch of events 108a, or events from the batch of events 108a, to a database. All events in the batch of events 108a can be committed to persistent storage.

Once the batch of events 108a is committed to persistent storage, the storage system 114, during time period TD, provides the intermediate system 112a with a commit confirmation message. For example, the storage system 114 can determine that the batch of events 108a is committed to persistent storage. In response, the storage system can generate the confirmation message that includes the batch identifier 110. The storage system 114 can send the confirmation message that includes the batch identifier to the intermediate system 112a.

When there are other systems between the storage system 114 and the intermediate system 112a, the storage system 114 provides the commit confirmation message to the system from which the storage system 114 received the batch identifier 110. For instance, when an event stream includes a second to last system that provides the batch identifier 110 to the storage system 114, the storage system 114 provides the commit confirmation message to the second to last system.

The intermediate system 112a receives the confirmation message and competes a transaction for the batch of events 108a-b. For instance, the intermediate system 112a can maintain data in non-persistent memory for the batch of events 108a-b and the batch identifier 110. Upon receiving the confirmation message, the intermediate system 112a can remove the data from the non-persistent memory. In some examples, the non-persistent memory can include a buffer, e.g., a queue, that includes the batch of events 108a-b and the batch identifier 110. The first intermediate system 112 can remove the batch of events 108a-b and the batch identifier from the buffer.

During time period T_{C}, the intermediate system 112a can periodically determine whether the intermediate system 112a received a confirmation that indicates that the batch of events has been stored to persistent memory. For instance, the intermediate system 112a can use a batch specific timer, a schedule, e.g., for all batches processed by the intermediate system 112a, or another appropriate process to determine whether a threshold period of time has passed. Upon determining that a threshold period of time has passed, e.g., that indicates that the batch of events 108a might not be committed to persistent storage, the intermediate system 112a can determine whether a commit confirmation has been received for the batch of events 108a-b.

When the intermediate system 112a determines that a commit confirmation has not been received for the batch of events 108a-b, the intermediate system 112a can determine to re-send the batch of events 108a and the batch identifier 110 to another system. This can include the intermediate system 112a determining to re-send the batch of events 108a and the batch identifier 110 to the same storage system 114 to which the intermediate system 112a previously sent the batch of events 108a and the batch identifier 110, or another storage system.

The intermediate system 112a can select the system to which the batch of events 108a and the batch identifier 110 should be re-sent using any appropriate process. For instance, the intermediate system 112a can select a live downstream system that stores data of the type included in the batch of events 108a, is identified as available for storing data to persistent storage, or both, as the system to which the intermediate system 112a should re-send the batch of events 108a and the batch identifier 110.

When the intermediate system 112a determines that the commit confirmation has been received, the intermediate system 112a need not determine whether the threshold period of time has passed. For instance, when the intermediate system 112a receives the commit confirmation from the storage system 114, the intermediate system 112a can remove data for the batch of events 108a-b and the batch identifier 110 from non-persistent memory and need not determine whether a threshold period of time has passed and the batch of events 108a-b might not be stored to persistent storage.

In some examples, the intermediate system 112a determines that the threshold period of time has passed for the batch of events 108a only when the commit confirmation has not been received. For instance, the intermediate system 112a can initiate a timer for the batch of events 108a when the batch of events 108a is sent to the storage system 114. When the intermediate system 112a receives a commit confirmation for the batch of events 108a, the intermediate system 112a disables the timer. As a result, the timer would not expire for the batch of events 108a when the commit confirmation was received.

When the intermediate system 112a determines that the commit confirmation has been received for the batch of events 108a, the intermediate system 112a and send a commit confirmation upstream. For instance, during time period T_{E}, the intermediate system 112a can send the commit confirmation with the batch identifier 110 upstream, e.g., to the service 102a.

The upstream system, e.g., the service 102a, can receive the commit confirmation with the batch identifier 110. The upstream system can then perform a process similar to that performed by the intermediate system 112a. For example, the service 102a can remove data from non-persistent memory for the batch of events 108a and the batch identifier 110.

The HTTP client 102c can create a second batch of events 108b using a time period and an event type. For instance, the HTTP client 102c can determine events with timestamps within a time period. The time period can be a duration for a maximum time period from which the client daemon 104c can select events for a batch. When the time period starts at T₀ and has a duration of n, the client daemon 104c can select events for the second batch of events 108b that have timestamps within T₀ to T₀₊ₙ, inclusive.

This event selection process can include the client daemon 104c selecting only events for the HTTP client 102c, e.g., generated by or provided to the HTTP client 102c, that have a particular event type. For example, when events can either be messages or images, the client daemon 104c can select only messages for the second batch of events 108b. In this example, the client daemon 104c can select only events that have an image event type for another batch of events.

Similar to the process described above for the batch of events 108a-b, the HTTP client 102c can provide the second batch of events 108b, with a corresponding second batch identifier, to a second intermediate system 112b. In some examples, the HTTP client 102c can provide the second batch of events 108b to the intermediate system 112a. In this example, the intermediate system 112a can process batches of events that all have the same event type, e.g., message or image, or batches of events that need not have the same event type.

The HTTP client 102c can generate a message for the second batch of events 108b. The message can include the second batch identifier, e.g., in a field of the message. The second batch identifier can be a transaction identifier, e.g., tid1. The message can include data that identifies a final destination for the second batch of events 108b. For instance, the message can include destination address, e.g., an identifier, for the storage system 114.

The second intermediate system 112b receives the second batch of events 108b and the second batch identifier from the HTTP client 102c. The second intermediate system can start a transaction upon receiving the second batch of events 108b with the second batch identifier, e.g., tid1. The second intermediate system 112b can queue the second batch of events 108b, e.g., in a non-persistent memory queue. The second intermediate system 112b can send the second batch of events 108b along with the second batch identifier, e.g., tid1, to another intermediate system (not shown).

The other intermediate system receives the second batch of events 108b along with the second batch identifier, e.g., tid1. Upon receiving the second batch of events 108b with the second batch identifier, the other system can start a transaction. The other intermediate system can send the second batch of events 108b along with the second batch identifier to the storage system 114, e.g., that is the final destination for the second batch of events 108b.

Although this specification refers to the storage system 114 as the final destination, the storage system 114 or another system can send data for the second batch of events to another destination. In this regard, the storage system 114 is the final destination with respect to where the second batch of events 108b will be stored in persistent storage rather than what is done with data in the second batch of events 108b after the data is stored in persistent storage.

The storage system 114 receives the second batch of events 108b along with the second batch identifier, e.g., tid1. In response to this receipt, the storage system 114 starts a transaction for the second batch of events 108b and writes the second batch of events 108b to persistent storage.

While the second batch of events 108b is sent through the various intermediate systems 112 to the storage system 114, the prior systems and devices, e.g., the HTTP client 102c, wait for a commit confirmation before committing the transaction that is for sending the second batch of events 108b to persistent storage. Upon receipt of a commit confirmation, these systems and devices can commit the corresponding transaction.

These systems and devices do not need to wait for a commit confirmation before starting a transaction for another batch of events. For instance, while the HTTP client 102c is waiting for a commit confirmation for the second batch of events 108b, sent through the second intermediate system 112b, the HTTP client 102c can send a third batch of events to the intermediate system 112a for storage in persistent memory. The third batch of events can be of the same event type or a different event type as the second batch of events.

Similarly, while waiting for a commit confirmation for the second batch of events 108b with the second batch identifier, the second intermediate system 112b can add entries to its queue for other batches of events. The second intermediate system 112b can initiate transactions for these other batches of events, process data for these other batches of events, or both.

Once the storage system 114 successfully writes the second batch of events 108b to persistent storage, the storage system 114 commits the transaction successfully. For example, once the batch of events 108b is committed to persistent storage, a commit acknowledgment is sent back to its source, which would acknowledge the transaction batch and send the same acknowledgment upstream by tracing back the event hops. Ultimately the client, e.g., the HTTP client 102c, which initiated the event batch can get an acknowledgment of the batch identifier 110 and frees up the buffer it has maintained for the batch of events 108b.

The storage system 114 sends a commit confirmation message that includes the second batch identifier, e.g., tid1, to the other intermediate system. The storage system 114 can commit the transaction successfully and then send the commit confirmation. The storage system 114 can send the commit confirmation and then commit the transaction successfully. In some examples, the storage system 114 can, substantially concurrently, commit the transaction successfully and send the commit confirmation.

The other system receives the commit confirmation from the storage system 114. In response, the other system commits its corresponding transaction successfully. The other system also sends a commit confirmation message, with the second batch identifier, to the second intermediate system 112b which performs a similar process. In response, the second intermediate system 112b commits its transaction and sends a commit confirmation message to the HTTP client 102c. Similarly, upon receiving the commit confirmation message, the HTTP client 102c successfully commits its corresponding transaction.

When the other system receives a commit confirmation, the other system can use the included batch identifier to determine the transaction to which the commit confirmation corresponds. For example, the other system can have multiple initiated transactions. The multiple initiated transactions can include transactions for storing batches of events in a single persistent storage, or multiple different persistent storages. The multiple initiated transactions can be for batches of events received from multiple different clients 102a-c. The other system can use the batch identifier to determine which of the multiple initiated transactions was successfully committed to persistent storage and the other system should commit successfully.

When there are any failures in the commit transaction chain, the event processing pipeline can roll back the chain. For instance, when the other system does not receive a commit confirmation, the other system can resend the second batch of events 108b and the second batch identifier to a storage system, e.g., the storage system 114 or another storage system. When the second intermediate system 112b does not receive a commit confirmation, the second intermediate system 112b can resend the second batch of events 108b and the second identifier to a downstream system in the event processing pipeline, e.g., the other system or a second system. When the HTTP client 102c does not receive a commit confirmation, the HTTP client 102c can send resend the second batch of events 108b and the second identifier to a system in the same layer as the intermediate system 112a and the second intermediate system 112b.

In some implementations, a system or device can receive a commit confirmation for a first transaction after receiving a commit confirmation for a second transaction that was initiated after the first transaction. For instance, in the event processing pipeline of the environment 100, order need not matter. Each batch can be independent from the other batches and handled using an independent batch identifier 110. Since the batches can be handled asynchronously, the systems and devices in the event processing pipeline can commit and acknowledge identifiers in parallel. This can increase system, device, event processing pipeline, or a combination of these, efficiency as the identifiers need not be processed in order.

The second intermediate system 112b can initiate a first transaction for the second batch of events 108b. Afterward, the second intermediate system 112b can initiate a second transaction for a third batch of events, e.g., received from the client 102b. The second intermediate system 112b can then receive a commit confirmation for the third batch of events before receiving a commit confirmation for the second batch of events 108b.

In some implementations, the storage system 114 cannot scale to the number of potential clients in the environment 100. For instance, when the environment includes hundreds of thousands of clients 102a-c, the storage system 114 cannot directly connect to and receive data from all of the clients, e.g., that include the service 102a and the clients 102b-c. To enable the environment 100 to store data in persistent storage on the storage system 114, the environment 100 can include thousands of systems in the intermediate layers of the event processing pipeline. The intermediate layers can include the intermediate systems 112a-b.

In some implementations, the storage system 114 might store the same batch of events 108a-b in persistent memory twice. This might occur when the storage system 114 stores the batch of events 108a in persistent storage, commits the transaction for the batch of events 108a, and sends a commit confirmation to the intermediate system 112a that is lost, e.g., due to a network failure. When the intermediate system 112a determines that a commit confirmation was not received, the intermediate system 112a can resend the batch of events 108a, with the batch identifier 110, to the storage system 114. The storage system would then initiate a second transaction for the batch of events 108a, store the batch of events 108a in persistent storage again, commit the second transaction, and send a second commit confirmation to the intermediate system 112a.

In these implementations, the storage system 114 or another system in the environment 100 can de-duplicate events or batches of events that have been stored in persistent storage, are requested for storage in the persistent storage, or both. The system can use the batch identifier 110 to determine whether batches of events have been stored in persistent storage more than once. For instance, the system can store a batch of events, or individual events, in the persistent storage and include the batch identifier 110 with the stored data. The system can analyze the batch identifiers 110 in the persistent storage to determine whether multiple events, or batches of events, have the same batch identifier.

When multiple events or batches of events have the same identifier, the system can remove the duplicate events. The system can remove duplicate batches when a batch identifier occurs more than once in the persistent storage. The system can remove duplicate events when two or more events each have the same batch identifier and other common data, such as an event identifier. In some examples, the system can compare data in the entries, e.g., database entries, for events that have the same batch identifier to determine whether the entries are for the same event. When two entries have the same data, or at least a threshold amount of data in common, the system can determine that the two entries are for the same event and remove one of the entries from persistent storage.

Another system in the environment 100 that can perform de-duplication analysis can include the intermediate system 112a. For instance, when the intermediate system 112a receives a batch of events 108a, the intermediate system 112a can determine whether the intermediate system 112a already initiated a transaction for the batch identifier 110, e.g., whether the batch identifier 110 is already included in the intermediate system's 112a queue. This can occur when a connection between the intermediate system 112a and the storage system 114 failed and the intermediate system 112a already re-sent the batch of events 108a for storage in a persistent storage. When the intermediate system 112a determines that the intermediate system 112a already initiated a transaction for the batch identifier 110, the intermediate system can determine to skip initiating another transaction for the batch identifier 110, skip sending another request for the batch of events 108a, e.g., at this time, or both. The intermediate system 112a can then process the batch of events 108a as if it had not received the subsequent request to process the batch of events 108a but instead only received a single request to process the batch of events 108a.

The clients 102a-c are an example of a system implemented as computer programs on one or more computers in one or more locations, in which the systems, components, and techniques described in this specification are implemented. The clients, e.g., the service 102a, the client 102b, or the HTTP client 102c, can be implemented on a personal computer, a mobile communication device, a server, or another device that can send and receive data over the network 116a. The networks 116a-b, such as a local area network (LAN), wide area network (WAN), the Internet, or a combination thereof, connects the clients 102a-c, the intermediate systems 112a-b, and the storage system 114. The networks 116a-b can be the same network, e.g., the Internet, or different networks. The intermediate systems 112a-b, the storage system 114, or a combination of these, can use a single server computer or multiple server computers operating in conjunction with one another, including, for example, a set of remote computers deployed as a cloud computing service.

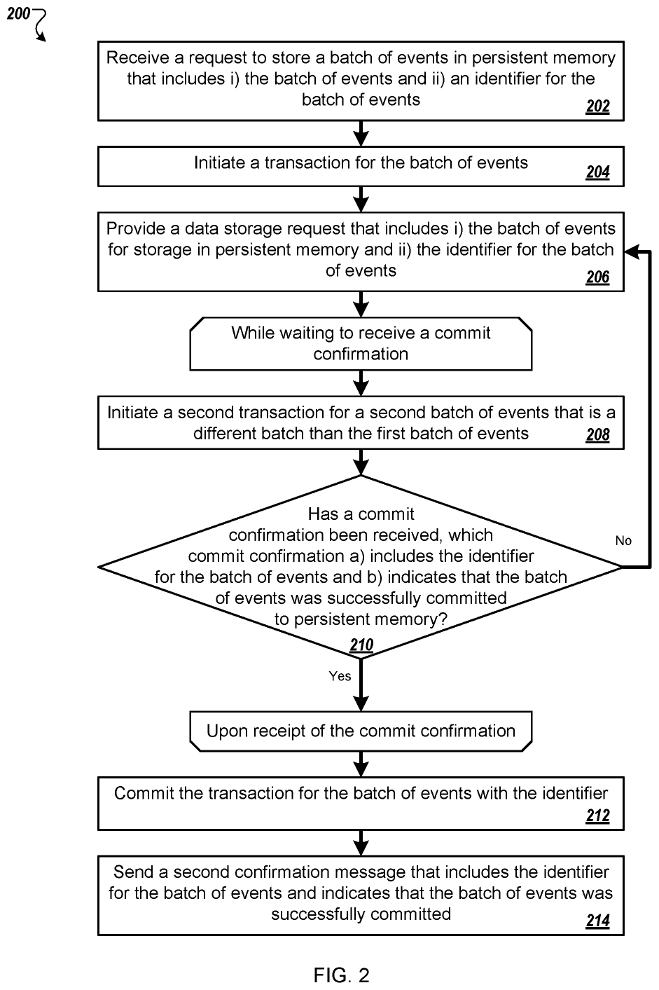

FIG. 2 is a flow diagram of an example process 200 for providing a batch of events for persistent storage. For example, the process 200 can be used by one of the intermediate systems 112a-b from the environment 100.

An intermediate system receives a request to store a batch of events in persistent memory (202). The request includes i) the batch of events and ii) an identifier for the batch of events. For instance, the intermediate system can receive the request from a client or another upstream system in an event processing pipeline. The intermediate system can receive the request using any appropriate network protocol. The request can be to store the batch of events in the persistent memory of a persistent memory layer in an event processing pipeline. At least some of the layers in the event processing pipeline can perform different event processing on an event that passes through the event processing pipeline, e.g., after an initiating layer receives the event.

The event processing pipeline can include one or more layers, including an intermediate layer that includes the intermediate system. The intermediate layer can include other systems in addition to the intermediate system, e.g., a second intermediate system.

The one or more layers can include an initiating layer. In some examples, the initiating layer can receive, create, or both, batches of events. For instance, systems, e.g., client devices, in the initiating layer can receive events. The systems in the initiating layer can create batches of events.

The intermediate system initiates a transaction for the batch of events (204). For example, the intermediate system stores an entry in a queue that identifies the batches of events the intermediate system is processing. The entry can include the identifier for the batch of events, data for the batch of events, or both. The data for the batch of events can be the event data, e.g., images when the events are images, messages when the events are messages, etc.

The intermediate system provides a data storage request that includes i) the batch of events for storage in persistent memory and ii) the identifier for the batch of events (206). The intermediate system can process the batch of events before providing the data storage request that includes the batch of events. This can include storing or aggregating the batch of events, or another appropriate process as described in more detail above. The intermediate storage system can use any appropriate process to provide the batch of events for storage.

The intermediate system can provide the data storage request to any appropriate downstream system in the event processing pipeline. For example, the intermediate system can provide the data storage request to another intermediate system in the event processing pipeline that is closer to a persistent storage than the intermediate system. In some examples, the intermediate system can provide the data storage request to a storage system that includes a persistent memory in which the batch of events will be stored. In some examples, the intermediate system can provide the data storage request to an event stream that will be processed by a downstream system in the event processing pipeline.

While waiting to receive a commit confirmation, the intermediate system initiates a second transaction for a second batch of events that is a different batch than the first batch of events (208). For example, the intermediate system can receive a second request to store the second batch of events in the persistent memory of the persistent memory layer in the event processing pipeline. The intermediate system can receive the second request from the same system from which the intermediate system received the request or from a different system. The second request can include the second batch of events and a second identifier for the second batch of events. In response to receipt of the second request, the intermediate system can initiate the second transaction for the second batch of events. The intermediate system can provide, e.g., to another downstream system, a second data storage request that includes i) the second batch of events for storage in the persistent memory of the persistent memory layer in the event processing pipeline and ii) the second identifier for the second batch of events. The other downstream system can be the same system to which the intermediate system sent the data storage request or a different system.

The intermediate system determines whether a commit confirmation has been received (210). If received, the commit confirmation can a) include the identifier for the batch of events and b) indicate that the batch of events was successfully committed to persistent memory. For instance, the intermediate system can determine whether a threshold period of time has pass since the intermediate system provided the data storage request. The threshold period of time can be specific to the batch of events, e.g., a timer. The threshold period of time can be for multiple batches of events, e.g., based on a schedule. When the threshold period of time has passed, the intermediate system can determine whether the commit confirmation has been received.

The intermediate system can determine whether the commit confirmation has been received using any appropriate process. For example, the intermediate system can include a queue that has entries for transactions that were initiated but have not yet been successfully committed. The intermediate system can search the queue for an entry that has the identifier and, if so, determine that a commit confirmation has not been received. In some examples, the intermediate system can determine that the commit confirmation for the batch of events has not been received based on the existence of an entry in a queue that includes the identifier for the batch of events.

In response to determining that the commit confirmation has not been received, the intermediate system can provide a second data storage request, e.g., proceed to step 206. The intermediate system can provide the second data storage request to the same downstream system to which the intermediate system provided the first data storage request. The intermediate system can provide the second data storage request to another downstream system in the event processing pipeline that is a different system from the system to which the intermediate system provided the first data storage request.

The intermediate system commits the transaction for the batch of events with the identifier (212). The intermediate system can commit the transaction in response to determining that the commit confirmation was received, e.g., by the intermediate system. For example, the intermediate system removes the entry from the queue that includes the identifier for the batch of events. The intermediate system can perform any appropriate action to commit the transaction.

The intermediate system sends a second confirmation message that includes the identifier for the batch of events and indicates that the batch of events was successfully committed (214). For instance, the intermediate system sends the second confirmation message to the upstream system from which the intermediate system received the request to store the batch of events. The intermediate system can forward the first confirmation message as the second confirmation message. In some examples, the intermediate system can generate a new confirmation message as the second confirmation message.

The order of steps in the process 200 described above is illustrative only, and providing the batch of events for persistent storage can be performed in different orders. For example, the intermediate system can provide the data storage request, e.g., perform step 206, and then initiate the transaction for the batch of events, e.g., perform step 204. In some examples, the intermediate system can send the second confirmation message, e.g., perform step 214, and then commit the transaction, e.g., perform step 212.

In some implementations, the process 200 can include additional steps, fewer steps, or some of the steps can be divided into multiple steps. For example, the intermediate system can perform a single step in which the intermediate system commits the transaction and sends the second confirmation. In some examples, the intermediate system can both commit the transaction and send the second confirmation message in response to determining that the commit confirmation has been received.

In some implementations, an event can be a message, e.g., a tweet, an image, or an advertisement. In these implementations, a user device can generate the event, e.g., the message. The user device can provide the event to one of multiple clients, e.g., the clients 102a-c shown in FIG. 1, for storage of the event in persistent storage. Storage of the event in persistent storage can enable later retrieval, analysis, or both, of the message, e.g., so that the event processing pipeline can provide the message to another device or system.

The client that received the message can create a batch of messages. Each of the events in the batch can have the same type. For instance, the client can create a first batch of messages and a second batch of images. The client generates a batch identifier for the batch of messages. The client can provide the batch of messages with the batch identifier to an intermediate system.

The intermediate system can collect events, aggregate events, or perform another appropriate process. For instance, when a storage system is unable to process a high volume of requests from a high volume of clients, the intermediate system can collect multiple batches of events, e.g., batches of messages, from various clients and send the batches to the storage system to enable event storage on the storage system.

The intermediate system can determine a storage system to which the batch of messages should be sent. This can occur when different storage systems are used to maintain, in persistent storage, different event types. For instance, a first storage system can store messages while a second storage system can store images.

The intermediate system can send the batch of messages to the storage system. The storage system receives the batch of messages and stores the batch of messages in persistent storage.

The storage system, or another system, can analyze events stored in persistent storage and provide events to another user device. For instance, an analysis system can analyze messages stored in persistent storage and determine one or more messages to send to another user device. The determined messages can include the message that the user device provided to the client. In this example, the analysis system can determine that the other user device is associated with an account that follows, or has otherwise shown interest in, an account for the user device.

The analysis system can provide the determined one or more messages to the other user device. This provision can cause the other user device to present a user interface that depicts content for the one or more messages. For instance, the other user device can present a user interface with a timeline that includes the content for the one or more messages.

By using the systems and methods described in this specification, the event processing pipeline can improve event processing, as described in more detail above. This can include improving a likelihood that the message the user device sent to the client is stored in persistent storage which can result in an improved likelihood that the message is presented in the user interface for the other user device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
receiving, from an upstream system in an event processing pipeline that includes a plurality of systems within one or more layers a) including a persistent memory layer and b) at least some layers of which perform different event processing on an event that passes through the event processing pipeline after the event is received by an initiating layer, a request to store a first batch of events in persistent memory of the persistent memory layer in the event processing pipeline, the request including i) the first batch of events and ii) a first identifier for the first batch of events;
initiating a first transaction for the first batch of events;
providing, to a downstream system in the event processing pipeline, a data storage request that includes i) the first batch of events for storage in persistent memory of the event processing pipeline and ii) the first identifier for the first batch of events;
while waiting to receive a first confirmation that indicates that the first batch of events was successfully committed to the persistent memory of the persistent memory layer in the event processing pipeline, initiating a second transaction for a second batch of events that is a different batch than the first batch of events;
receiving, from the downstream system, the first confirmation that a) includes the first identifier for the first batch of events and b) indicates that the first batch of events was successfully committed to the persistent memory of the persistent memory layer in the event processing pipeline; and
in response to receiving the first confirmation:
committing the first transaction for the first batch of events with the first identifier; and
sending, to the upstream system, a second confirmation message that includes the first identifier for the first batch of events and indicates that the first batch of events was successfully committed.

2. The system of claim 1, wherein committing the first transaction for the first batch of events with the first identifier comprises removing data for the first batch of events from a buffer.

3. The system of claim 1, wherein the first identifier comprises a timestamp for the first batch of events and a client identifier for a client device that created the first batch of events.

4. The system of claim 1, wherein a client device selects a number of events for the first batch of events using at least one of: (i) a time period during which the events in the first batch of events were created, or (ii) a size of the events included in the first batch of events.

5. The system of claim 1, the operations comprising:
for a third batch of events that is a different batch than the first batch of events:
initiating a third transaction for the third batch of events with a third identifier including storing data for the third batch of events in a buffer;
providing, to a second downstream system, a second data storage request that includes i) the third batch of events for storage in the persistent memory of the persistent memory layer and ii) the third identifier;
determining that a threshold period of time has passed after providing the second data storage request without receiving a second confirmation that a) includes the third identifier and b) indicates that the third batch of events was successfully committed to the persistent memory of the persistent memory layer; and
in response to determining that the threshold period of time has passed after providing the second data storage request without receiving the second confirmation, providing, to a third downstream system and using the data for the third batch of events that was stored in the buffer, a third data storage request that includes i) the third batch of events for storage in the persistent memory of the persistent memory layer and ii) the third identifier.

6. The system of claim 5, wherein at least one of the first batch of events, the second batch of events, or the third batch of events includes two or more events.

7. The system of claim 5, wherein:
the second downstream system is the same system as the third downstream system; and
the second data storage request comprises the same data values as the third data storage request.

8. The system of claim 1, the operations comprising:
after initiating the first transaction for the first batch of events and before committing the first transaction for the first batch of events:
receiving a second request to store the second batch of events in the persistent memory of the persistent memory layer in the event processing pipeline, the second request including i) the second batch of events and ii) a second identifier for the second batch of events;
initiating the second transaction for the second batch of events; and
providing a second data storage request that includes i) the second batch of events for storage in the persistent memory of the persistent memory layer in the event processing pipeline and ii) the second identifier for the second batch of events.

9. A computer-implemented method comprising:
receiving, from an upstream system in an event processing pipeline that includes a plurality of systems within one or more layers a) including a persistent memory layer and b) at least some layers of which perform different event processing on an event that passes through the event processing pipeline after the event is received by an initiating layer, a request to store a first batch of events in persistent memory of the persistent memory layer in the event processing pipeline, the request including i) the first batch of events and ii) a first identifier for the first batch of events;
initiating a first transaction for the first batch of events;
providing, to a downstream system in the event processing pipeline, a data storage request that includes i) the first batch of events for storage in persistent memory of the event processing pipeline and ii) the first identifier for the first batch of events;
while waiting to receive a first confirmation that indicates that the first batch of events was successfully committed to the persistent memory of the persistent memory layer in the event processing pipeline, initiating a second transaction for a second batch of events that is a different batch than the first batch of events;
receiving, from the downstream system, the first confirmation that a) includes the first identifier for the first batch of events and b) indicates that the first batch of events was successfully committed to the persistent memory of the persistent memory layer in the event processing pipeline; and
in response to receiving the first confirmation:
committing the first transaction for the first batch of events with the first identifier; and
sending, to the upstream system, a second confirmation message that includes the first identifier for the first batch of events and indicates that the first batch of events was successfully committed.

10. The method of claim 9, wherein committing the first transaction for the first batch of events with the first identifier comprises removing data for the first batch of events from a buffer.

11. The method of claim 9, wherein the first identifier comprises a timestamp for the first batch of events and a client identifier for a client device that created the first batch of events.

12. The method of claim 9, wherein a client device selects a number of events for the first batch of events using at least one of: (i) a time period during which the events in the first batch of events were created, or (ii) a size of the events included in the first batch of events.

13. The method of claim 9, comprising:
for a third batch of events that is a different batch than the first batch of events:
initiating a third transaction for the third batch of events with a third identifier including storing data for the third batch of events in a buffer;
providing, to a second downstream system, a second data storage request that includes i) the third batch of events for storage in the persistent memory of the persistent memory layer and ii) the third identifier;
determining that a threshold period of time has passed after providing the second data storage request without receiving a second confirmation that a) includes the third identifier and b) indicates that the third batch of events was successfully committed to the persistent memory of the persistent memory layer; and
in response to determining that the threshold period of time has passed after providing the second data storage request without receiving the second confirmation, providing, to a third downstream system and using the data for the third batch of events that was stored in the buffer, a third data storage request that includes i) the third batch of events for storage in the persistent memory of the persistent memory layer and ii) the third identifier.

14. The method of claim 13, wherein at least one of the first batch of events, the second batch of events, or the third batch of events includes two or more events.

15. The method of claim 13, wherein:
the second downstream system is the same system as the third downstream system; and
the second data storage request comprises the same data values as the third data storage request.

16. The method of claim 9, comprising:
after initiating the first transaction for the first batch of events and before committing the first transaction for the first batch of events:
receiving a second request to store the second batch of events in the persistent memory of the persistent memory layer in the event processing pipeline, the second request including i) the second batch of events and ii) a second identifier for the second batch of events;
initiating the second transaction for the second batch of events; and
providing a second data storage request that includes i) the second batch of events for storage in the persistent memory of the persistent memory layer in the event processing pipeline and ii) the second identifier for the second batch of events.

17. A non-transitory computer storage medium encoded with instructions that, when executed by one or more computers, cause the one or more computers to perform operations comprising:
receiving, from an upstream system in an event processing pipeline that includes a plurality of systems within one or more layers a) including a persistent memory layer and b) at least some layers of which perform different event processing on an event that passes through the event processing pipeline after the event is received by an initiating layer, a request to store a first batch of events in persistent memory of the persistent memory layer in the event processing pipeline, the request including i) the first batch of events and ii) a first identifier for the first batch of events;
initiating a first transaction for the first batch of events;
providing, to a downstream system in the event processing pipeline, a data storage request that includes i) the first batch of events for storage in persistent memory of the event processing pipeline and ii) the first identifier for the first batch of events;
while waiting to receive a first confirmation that indicates that the first batch of events was successfully committed to the persistent memory of the persistent memory layer in the event processing pipeline, initiating a second transaction for a second batch of events that is a different batch than the first batch of events;
receiving, from the downstream system, the first confirmation that a) includes the first identifier for the first batch of events and b) indicates that the first batch of events was successfully committed to the persistent memory of the persistent memory layer in the event processing pipeline; and
in response to receiving the first confirmation:
committing the first transaction for the first batch of events with the first identifier; and
sending, to the upstream system, a second confirmation message that includes the first identifier for the first batch of events and indicates that the first batch of events was successfully committed.

18. The computer storage medium of claim 17, wherein committing the first transaction for the first batch of events with the first identifier comprises removing data for the first batch of events from a buffer.

19. The computer storage medium of claim 17, wherein the first identifier comprises a timestamp for the first batch of events and a client identifier for a client device that created the first batch of events.

20. The computer storage medium of claim 17, wherein a client device selects a number of events for the first batch of events using at least one of: (i) a time period during which the events in the first batch of events were created, or (ii) a size of the events included in the first batch of events.
